(19) United States
(12) Patent Application Publication
(10) Pub. No.: US 2010/0225215 A1
(43) Pub. Date: Sep. 9, 2010

(54) Multi-chip cup semi-conductor lamp

(76) Inventor: Han-Ming Lee, Hsin Chu City (TW)

Correspondence Address: Han-Ming LEE, P.O. BOX 7-820, TAIPEI, TW

(21) Appl. No.: 12/380,645

(22) Filed: Mar. 3, 2009

(51) Int. Cl. H01J 7/44

(52) U.S. Cl. 313/1

(57) ABSTRACT

The present invention relates to a multi-chip cup semi-conductor lamp, comprising a silicon lamp cover, lamp housing, conducting plates, insulators, chip-cup lamp seat, chips, and conducting wires. The improvement including the chip-cut lamp seat is provided with a plurality of chip cups so that a single large power chip can be inserted as a plurality of small power chips of equal power, and the insulators, conducting plates, lamp housing, and silicon lamp cover are integrated in turn to create chip lighting sources of equally high power to achieve the effects of low temperature, low power consumption, and long service life.

### BACKGROUND OF THE INVENTION

Thanks to the high-tech civilization, with the ever-growing urban population and limited land resources, high buildings can be built to achieve greater utilization space. However, the floors of the buildings still rely on traditional fluorescent lights or light bulbs as the light source. According to the structure of the lamps, 2 conducting pin bridged Tungsten wires are provided in the traditional glass light housing and then connected to current so that the Tungsten wires give off light and heat. In recent years, with the advancement of the electronic industry, the lamps have been gradually replaced by LED lights. However, the high heat effect of the LED lights still may cause the LED lights to decay too early, therefore reducing the service life of the LED lights. Hence, it is indeed necessary to improve the structure of the LED light to perfect it.

### SUMMARY OF THE INVENTION

The primary purpose of the present invention is to provide a multi-chip cup semi-conductor lamp and in particular to one that comprises the silicon light cover, light housing, conducting plates, insulators, chip-cup lamp seat, chips, and conducting wires to create chip lighting sources of equally high power to achieve the effects of low temperature, low power consumption, and long service life.

The secondary purpose of the present invention is to provide a multi-chip cup semi-conductor lamp, wherein the chip-cup lamp seat is provided with a plurality of chip cups so that a single large power chip can be inserted into it as a plurality of small power chips of equal power.

Another purpose of the present invention is to provide a multi-chip cup semi-conductor lamp, wherein the insulators, conducting plates, lamp housing, and silicon lamp cover are installed in turn to be assembled and integrated rapidly.

### BRIEF DESCRIPTION OF THE DRAWINGS

FIG. 1 is a 3D diagram of the present invention.

FIG. 2 is a schematic diagram of the components of the present invention.

FIG. 3 is a cross-section 3D diagram of the present invention.

FIG. 4 is a 3D schematic of the lighting chip of the present invention.

FIG. 5 is a schematic of the semi-conductor lamp of the present invention used in the embedded lamp.

FIG. 6 is a schematic of the semi-conductor lamp of the present invention forming the embedded lamp.

### DETAILED DESCRIPTION OF THE PREFERRED EMBODIMENT

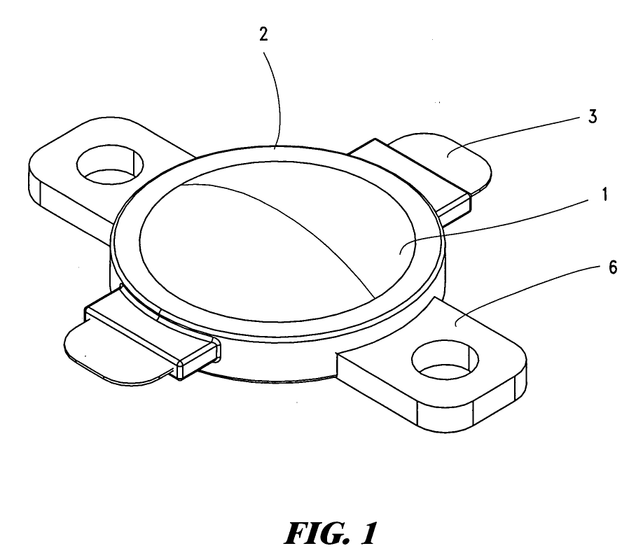

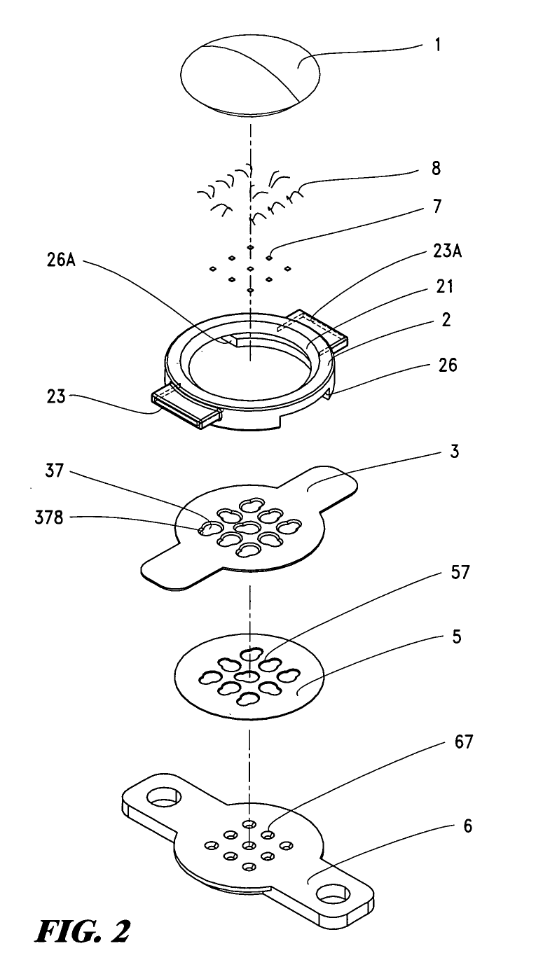

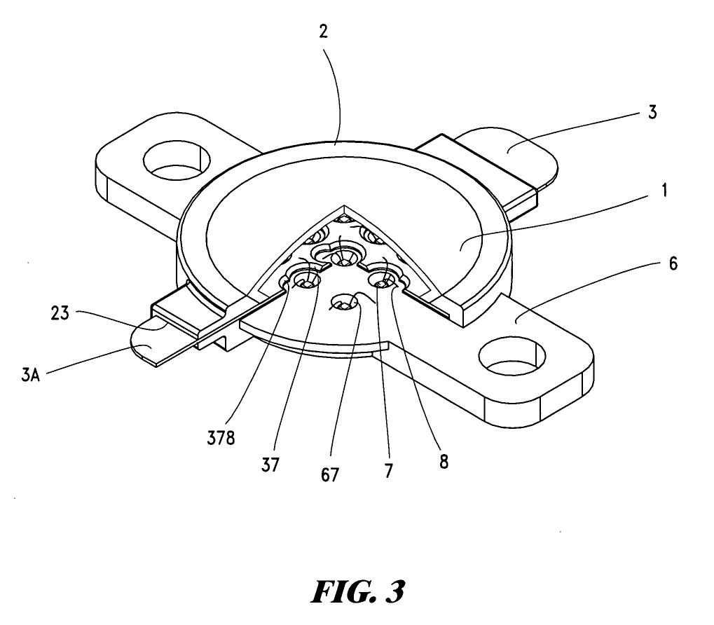

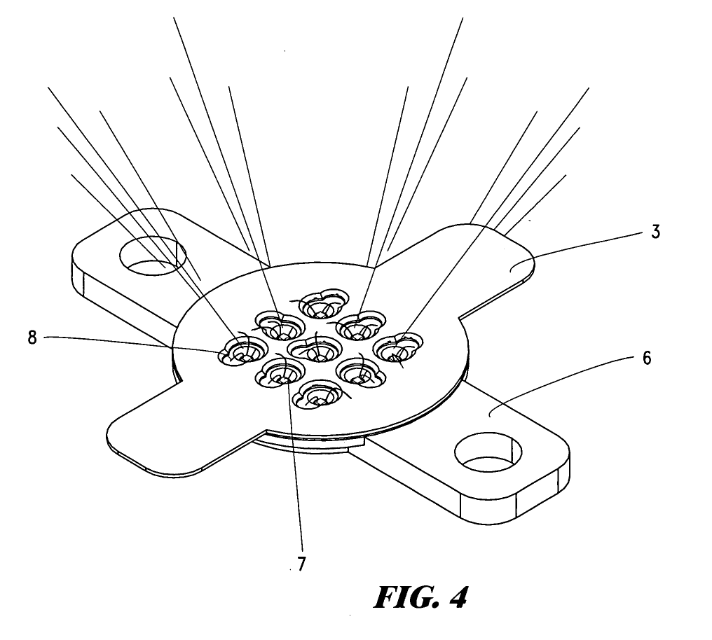

Please refer to FIG. 1 through FIG. 4, the multi-chip cup semi-conductor lamp of the present invention comprises silicon lamp cover 1, lamp housing 2, conducting plate 3, insulator 5, chip-cup lamp seat 6, chip 7, and conducting wire 8; silicon lamp cover 1 is a semi-round lamp cover made of transparent materials; lamp housing 2 is a round disk made of insulating materials with a concave ring hole 21 at the top for the installation of the outer ring below silicon lamp cover 1 and the disk is provided with concave grooves 23, 23A, 26, and 26A beneath itself; conducting plate 3 is a round plate with a plurality of taper holes 37 on the surface, the side of the taper holes are provided with semi-taper concave groove 378, the front end and the back end of the round plate surface are projected with two plates for being enclosed into the front and the back 23 and 23A of the concave groove below lamp housing 2; insulator 5 is a round piece in relative to conducting plate 3, the round plate is provided with holes 57 on the surface in relative to taper holes 37 on conducting plate 3 for attaching to the beneath of conducting plate 3; chip-cup lamp seat 6 is a round with two plates projecting on the left and the right, the round plate is provided with a plurality of chip cups 67 on the surface in relative to taper holes 37 on conducting plate 3; a positioning hole is provided between the two plates for the positioning of the screw and the two plates are provided for the installation of the left and the right concave grooves 26 and 26A below lamp housing 2; chip 7 is a semi-conductor chip to be installed into a plurality of chip cups 67; conducting wire 8 is made of conducting material and connected to chip 7 on one end and to conducting plate 3 or chip-cup lamp seat 6 on the other end.

The main improvement of the embodiment of the present invention includes: chip-cup lamp seat 6 is provided with a plurality of chip cups 67 so that a single large power chip can be inserted as a plurality of small power chips 7 of equal power, insulators 5, conducting plates 3, lamp housing 2, and silicon lamp cover 1 are integrated in turn, the other end of conducting wire 8 passes through concave grooves 378 to connect to the chip-cup lamp seat 6 to achieve the white light effect and chip lighting sources of equally high power so as to achieve the effects of low temperature, low power consumption, and long service life.

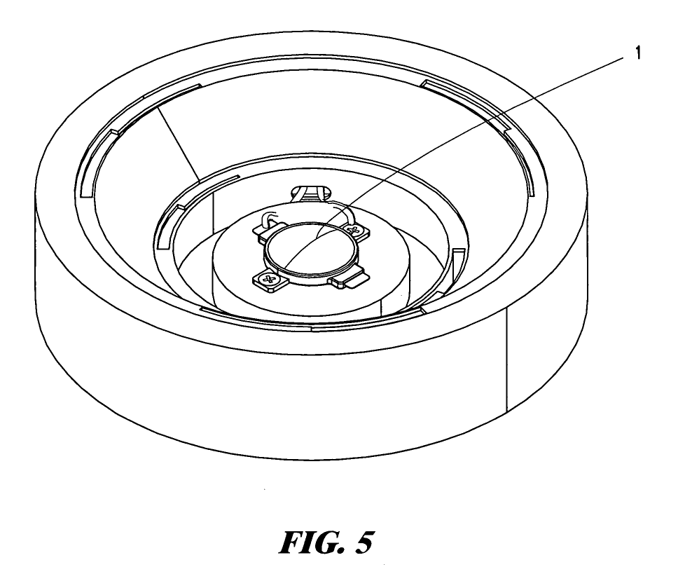

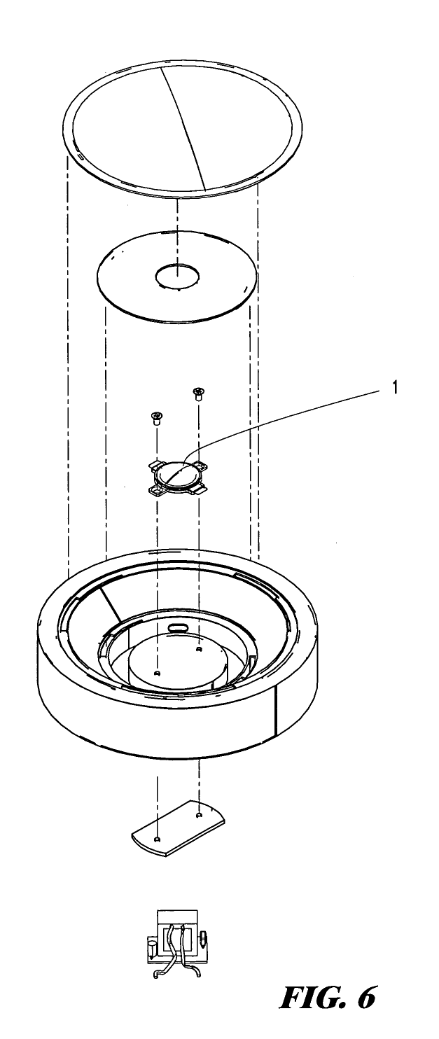

Please refer to FIG. 5 and FIG. 6 for another embodiment of the present invention. The semi-conductor lamp of the present invention can be installed into ordinary embedded lamps to fully replace the traditional high power consumption LED or bulbs, therefore significantly extending the service life of the lighting fixture and reducing the power consumption.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changers in the forms and details of the device illustrated and in its operation can be made by those skilled in the art without departing in any way from the spirit of the present invention.

I claim:

1. A multi-chip cup semi-conductor lamp, comprising the silicon lamp cover, lamp housing, conducting plates, insulators, chip-cup lamp seat, chips, and conducting wires, wherein:
The silicon lamp housing is a semi-round cover housing made of transparent material; the lamp housing is a round disk made of insulating materials with a concave ring hole at the top for the installation of the outer ring below the silicon lamp cover and the disk is provided with 4 concave grooves beneath itself;
The conducting plate is a round plate with a plurality of taper holes on the surface, the front end and the back end of the round plate surface are projected with two plates for being enclosed into the front and the back of the concave groove below the lamp housing;
The insulator is a round piece in relative to the conducting plate, the round plate surface is provided with holes in relative to the taper holes on the conducting plate for attaching to the beneath of the conducting plate;
The chip-cup lamp seat is a round with two plates projecting on the left and the right, the round plate surface is provided with a plurality of chip cups in relative to the taper holes on the conducting plate; a positioning hole is provided between the two plates for the positioning of the screw and the two plates are provided for the installation of the left and the right concave grooves below the lamp housing;
The chip is a semi-conductor chip to be installed into a plurality of chip cups;
The conducting wire is made of conducting material and connected to the chip on one end and to the conducting plate or the chip-cup lamp seat on the other end;
Through the above structure, the chip-cup lamp seat is provided with a plurality of chip cups so that a single large power chip can be inserted as a plurality of small power chips of equal power to create chip lighting sources of equally high power to achieve the effects of low temperature, low power consumption, and long service life.

2. A multi-chip cup semi-conductor lamp according to claim one, wherein the taper holes of the conducting plate is provided with semi-round taper concave grooves for the other end of the conducting wire to connect to the chip-cup lamp seat to achieve the white light effect.
